(19) United States
(12) Patent Application Publication
(10) Pub. No.: US 2016/0242594 A1
(43) Pub. Date: Aug. 25, 2016

(54) SYSTEM AND METHOD FOR PREPARING A BEVERAGE

(71) Applicant: K-FEE SYSTEM GMBH, Bergisch Gladbach (DE)

(72) Inventors: Gunter EMPL, Bergisch Gladbach (DE); Marc KRUGER, Bergisch Gladbach (DE)

(21) Appl. No.: 15/025,985

(22) PCT Filed: Oct. 17, 2014
(86) PCT No.: PCT/EP2014/072376

§ 371 Date: Mar. 30, 2016

(30) Foreign Application Priority Data
Oct. 18, 2013 (DE) 10 2013 221 234.8
Jun. 13, 2014 (DE) 10 2014 211 371.7

(51) Int. Cl. A47J 31/44; A23F 3/18; A23F 5/26; A47J 31/36; A23G 1/56; B65D 85/804; A47J 31/58; A47J 31/60; A47J 31/40; A23C 9/15

(52) U.S. Cl. CPC A47J 31/4492; A47J 31/407; A23F 3/18; A23F 5/262; A23C 9/1508; A23G 1/56; B65D 85/8046; A47J 31/58; A47J 31/60; A47J 31/3623; A23V 2002/00; B65D 2203/06

(57) ABSTRACT

The invention relates to a system for preparing a beverage, comprising a portion capsule which is filled with a raw beverage material, and a brewing device which comprises a brewing chamber for receiving the portion capsule and for extracting the beverage from the portion capsule by means of an extraction liquid. Said portion capsule comprises a product identifier and said brewing device comprises an identifier detector for identifying the identification of the portion capsule.

### PRIOR ART

The present invention relates to a system for preparing a beverage having a portion capsule, which contains a raw beverage material, and a brewing device, which comprises a brewing chamber for receiving the portion capsule and for extracting the beverage from the portion capsule by means of hot water.

Such a system is known for example from the document DE 10 2011 011 204 A1. The system comprises a portion capsule and a brewing device with a brewing chamber for extracting and/or dissolving a substance provided in the portion capsule, the brewing chamber having a first brewing chamber element and a second brewing chamber element and the first brewing chamber element being movable between a loading position, in which the first brewing chamber element and the second brewing chamber element are spaced apart from one another, and an extraction position, in which the first brewing chamber element and the second brewing chamber element are brought closer together to form an essentially closed brewing chamber, and each brewing chamber element respectively having a perforation means, the capsule cover being pierceable with the first perforation means and the bottom region of the portion capsule being pierceable with the second perforation means. The portion capsule is in this case specifically made to match the brewing device, in order always to ensure a trouble-free and reliable brewing operation and also a high quality of the beverage to be produced.

The popularity of such portion capsule brewing systems has grown steadily over the past years, so that in the meantime a large number of different portion capsule systems can be found on the market. The portion capsule and the brewing chamber machines of the respective systems often only differ slightly from one another externally, although the internal construction and the respective properties of the portion capsules in some cases differ greatly from one another. Consequently, the consumer disadvantageously runs the risk of inadvertently trying to use portion capsules of one portion capsule system to produce a beverage in a brewing device of another portion capsule system, as a result of which considerable damage to the brewing device may occur or there may even be a health risk for the user. For example, it is conceivable that the perforation means of one brewing unit, which are normally only intended for punching through a thin closure foil of the matching portion capsule, bend or even break off if they are operated with a portion capsule of a different system that has a rigid, stable distributing or filtering element directly underneath the closure foil. It would also be conceivable that the use of a portion capsule of a different system has the effect that the pressure conditions in the brewing chamber develop in an unpredictable way and lead to bursting of the portion capsule, or even of the entire brewing chamber, resulting in the risk of burns and the like for the users. There is also the risk that the brewing chamber no longer closes in a sealed manner, as a result of which hot extraction liquid sprays out of the device during the brewing in the brewing chamber.

Therefore, the prior art, for example the not yet published document DE 10 2012 105 787 A1, discloses systems for preparing beverages in which the portion capsule is provided with a special identifier and the associated portion capsule machine has an identifier for the detection of this special identifier. With a view to the functional capability and long service life of the portion capsule machine and to increase the safety of the user, before each brewing operation it can be checked on the basis of the identifier whether the portion capsule placed in is known and is suitable for brewing with the portion capsule machine.

A disadvantage of this solution is that for each portion capsule a special code has to be developed, stored, documented and processed.

### DISCLOSURE OF THE INVENTION

It was therefore the object of the present invention to provide a system for preparing a beverage by using portion capsules in which operation of the brewing device with portion capsules of a different system is prevented, without a dedicated code system having to be introduced in a laborious way.

The object is achieved by a system for preparing a beverage which has a portion capsule, which is filled with a raw beverage material, and a brewing device, which comprises a brewing chamber for receiving the portion capsule and for extracting the beverage from the portion capsule by means of extraction liquid, the portion capsule having a product identifier and the brewing device having an identifier detector for identifying the identification of the portion capsule.

The system according to the invention advantageously makes it possible on the basis of the product identifier to check the portion capsule before the brewing device is put into operation to ascertain whether the portion capsule concerned is an authorized, known portion capsule, i.e. a system-own portion capsule, that does not present any risk for the brewing device or the user. For example, it is conceivable that the brewing chamber cannot be closed or that the portion capsule simply falls through the brewing chamber or that the brewing operation can only start in a harmless mode or cannot start if the portion capsule cannot be clearly identified on the basis of its product identifier. In this way it is prevented that the brewing device is operated with a portion capsule of a different system. The risk of damage to the brewing device or the danger to persons caused by the brewing device being put into operation with such portion capsules of a different system is advantageously completely eliminated without requiring increased attentiveness on the part of the consumer. The checking of the portion capsule is in this case performed on the basis of the product identifier, so that no additional code system has to be introduced. Every food product is in any case provided with a unique, unmistakable product identifier, which assigns the product uniquely to a specific manufacturer. It is customary in the food trade to use this product identifier as a basis for checking stocks, documenting transport routes, providing evidence of origin or checking out products at automatic cash registers. The basic concept of the present invention is now to use this unique code, which is provided in any case, for carrying out the check in the brewing device to decide whether the brewing device is compatible with the portion capsule placed in, and consequently to allow the brewing operation to be safely initiated. The product identifier comprises in particular the so-called product identification number, in particular a Universal Product Code (UPC), a European Article Number (EAN), a GS1 code, a Global Trade Item Number (GTIN) or the like. In this way, no new code system needs to be introduced for this. In particular, the product identifier is in compliance with the GS1 standard. For the purposes of the present invention, the term extraction of the beverage comprises in particular the introduction of brewing liquid into the portion capsule. The raw beverage material located within the portion capsule may in this case be dissolved, brewed and/or dissolved out of the raw beverage material or separated from the raw beverage material. Consequently, beverages can in particular be produced from all the common types of raw beverage materials, such as granulated roasted coffee beans, macerated tea leaves or instant powder, for example instant coffee, instant chocolate or instant milk. It is also conceivable that the raw beverage material comprises a combination of soluble and separable substances, such as for example instant coffee and roasted coffee beans. The raw beverage material may equally well comprise a base material, in particular instant material, for the production of cold drinks.

Advantageous refinements and developments of the invention can be taken from the subclaims and the description with reference to the drawings.

According to a preferred embodiment of the present invention, it is provided that the product identifier is embedded in a bar code, an RFID code, a QR code, a data-matrix code or the like. In an advantageous way, automatic reading of the product identifier is consequently possible. The identifier detector comprises in particular an optical sensor, such as for example a camera, which automatically reads the bar code or QR code or the data-matrix code when the portion capsule is arranged within the brewing device. Alternatively, the identifier detector comprises a transmitting and receiving antenna for automatically reading the RFID codes. It would alternatively be conceivable that the product identifier is also embedded in other automatically readable computer chips. For the purposes of the present invention, the term QR code comprises in particular any data-matrix code. To this extent, hereinafter the terms QR code and data-matrix code are used synonymously. Alternatively or additionally, it would also be conceivable that the product identifier comprises a line code, a dot code, a binary code, a Morse code, a Braille code or the like. The code may in this case also be embedded in a three-dimensional structure, such as for example a relief.

According to a preferred embodiment of the present invention, it is provided that the brewing device comprises a control unit which only initiates or continues an extraction if the identifier detector detects a known product identifier. In particular, brewing liquid for extracting or brewing or dissolving the raw beverage material is only introduced if the identifier detector detects a known product identifier. It is conceivable that the brewing program automatically starts or is continued if the product identifier is detected. The brewing device preferably comprises a memory in which all of the product identifiers of all compatible portion capsules are stored, so that it is only necessary to compare by means of a control device whether the product identifier read in by means of the identifier detector is present in the list of stored (or known) product identifiers. Otherwise, the initiation of the brewing operation is prevented for safety reasons. It would also be conceivable that, after insertion, the extraction operation is initially started in a protected mode, for example with lower pressure or temperature, in which there is no damage to the machine or danger to the user even with a capsule of a different system, and, when the portion capsule is detected, the “matching extraction operation”, i.e. with the required pressure or the required temperature, is initiated. If the product identifier is not detected, for the sake of safety the machine remains in the “protected mode” or switches itself off.

According to a further preferred embodiment, it is provided that the brewing device comprises a control unit which starts a specific brewing program in dependence on the product identifier detected by the identifier detector. In an advantageous way, the brewing program matching the raw beverage material is consequently automatically selected. The various brewing programs preferably differ with regard to temperature, pressure, feed rate, feed time and/or feed pauses during the introduction of the brewing liquid into the portion capsule.

According to a further preferred embodiment, it is provided that the brewing device comprises a control unit which initiates an alternative process (also referred to as protected mode) if the identifier detector detects an unknown product identifier. If the product identifier is not recognized, it must be assumed that the current portion capsule is a portion capsule of a different system that has been designed for a different type of brewing device. It has been found in the past that the brewing device can be damaged by using such a portion capsule of a different system and/or that a proper brewing operation that is safe for the consumer cannot be ensured. For example, sometimes the use of portion capsules of a different system has the effect that the brewing chamber does not close in a watertight manner during the extraction operation, the portion capsule is wrongly pierced and/or the capsule bursts in the brewing chamber. This causes considerable risks of injury for the consumer, for example by scalding. Therefore, as a precaution, an alternative process that entails a lower risk of injury for the consumer is advantageously carried out if the product identifier is not recognized. The alternative process preferably comprises a capsule ejecting operation, a cleaning operation, a brewing program with a reduced amount of brewing water, a reduced brewing pressure and/or a reduced brewing water temperature.

The use of lower pressures, temperatures and/or amounts of water has the effect of reducing the risk of scalding for the consumer in the case of an unsealed brewing chamber or in the case of bursting of the brewing chamber. This can also be achieved by carrying out the cleaning operation that is in any case programmed in. Alternatively, the portion capsule is ejected directly.

According to a preferred embodiment of the present invention, it is provided that the system has a sales packaging in which the portion capsule is arranged before placement in the brewing device, the sales packaging being provided with the same product identifier. In an advantageous way, the same code that is already arranged in any case on the sales packaging and allows a unique assignment of the portion capsule is used for the product identifier arranged on the portion capsule. The product identifier arranged on the sales packaging serves in particular for identifying and tracking the portion capsule arranged in the sales packaging during the transport, storage and/or sale of the portion capsule.

A further subject matter of the present invention is a portion capsule for the system according to the invention, the portion capsule having a frustoconical base element with a cavity for receiving the raw beverage material and a capsule cover closing the cavity, the product identifier being arranged in the region of the capsule cover and/or in the region of a capsule flange and/or on the base element. In an advantageous way, the product identifier, and in particular the QR code or the data-matrix code, which represents the product identifier, can be arranged in the region of the capsule cover or the capsule flange in a particularly easy and low-cost way. Furthermore, this region is also comparatively easy to read for the identifier detector in a closed brewing chamber.

According to a preferred embodiment of the present invention, it is provided that the product identifier is embedded in a QR code and a plurality of the QR codes are arranged on a circular path one behind the other in the circumferential direction on the capsule cover. The portion capsule is constructed rotationally symmetrically about its longitudinal axis, as a result of which the orientation of the portion capsule in the brewing chamber is not precisely defined and will be different in each brewing operation. It can nevertheless be ensured by the arrangement of the plurality of identical QR codes on the circular path that there is always at least one QR code in the viewing field of the identifier detector. The QR codes are preferably arranged in this case in the region of a circular path with a radius of between 40 and 100 percent, preferably between 50 and 80 percent and particularly preferably between 55 and 65 percent of the total radius of the capsule cover. The mean diameter of the circular ring of QR codes preferably lies between 15 and 35 millimeters, particularly preferably between 20 and 30 millimeters and particularly preferably at essentially 26 millimeters. Alternatively, it is provided that the QR codes are arranged in the region of a circular path with a radius of between 20 and 100 percent, preferably between 30 and 60 percent, particularly preferably between 40 and 60 percent and most particularly preferably between 45 and 55 percent of the total radius of the capsule cover. The mean diameter of the circular ring of QR codes preferably lies between 10 and 20 millimeters, particularly preferably between 12 and 15 millimeters and particularly preferably at essentially 13.5 millimeters. Each QR code is preferably of a square form, the edge length preferably lying between 1 and 5 millimeters, particularly preferably between 1.5 and 2.1 millimeters and particularly preferably at essentially 1.8 millimeters. In this region, the multiplicity of identical QR codes can advantageously be realized in a size that can still be detected comparatively easily by the identifier detector.

The spacing between two neighboring QR codes along the circular ring preferably lies between 1 and 2 millimeters, particularly preferably between 1.2 and 1.8 millimeters and particularly preferably at essentially 1.5 millimeters. Advantageously, sufficient space remains in the center of the capsule cover to allow the perforation means to perforate the capsule cover when extracting the portion capsule and allow the extraction liquid to be conducted into the interior of the portion capsule. The viewing field of the identifier detector has a width of preferably between 3 and 6 millimeters, particularly preferably between 4 and 5 millimeters and particularly preferably of essentially 4.5 millimeters. The viewing field of the identifier detector also has a length of preferably between 7 and 11 millimeters, particularly preferably between 8 and 10 millimeters and particularly preferably of essentially 9 millimeters.

According to a preferred embodiment of the present invention, it is provided that each QR code has a maximum first extent in the circumferential direction and that a spacing is respectively provided between two neighboring QR codes, the spacing being less than, equal to or greater than the first extent.

According to a preferred embodiment of the present invention, it is provided that the portion capsule comprises at least one carrier foil and a transparent cover foil, the QR code being arranged between the carrier foil and the cover foil and in particular being printed onto the rear side of the cover foil. In an advantageous way, the QR code is consequently protected from scratching by the cover foil. Preferably, the carrier foil in this case faces the base element, while the cover foil faces away from the base element.

According to a preferred embodiment of the present invention, it is provided that the QR code is printed with an ink that reflects ultraviolet light. It is conceivable that the QR code is printed with an ink that is visually not as easily visible for the human eye in daylight than under artificial UV light. In an advantageous way, the outer appearance of the portion capsule on the cover of which the brand or the respective type of beverage is typically printed in a visually appealing way is not impaired, or only insignificantly, by the plurality of QR codes.

According to a preferred embodiment of the present invention, it is provided that the base element has a peripheral flange, to which the capsule cover is fastened, the plurality of QR codes being arranged on a circular path one behind the other in the circumferential direction on an underside of the flange that is facing away from the capsule cover. During the brewing operation, the flange is firmly clamped between the closure element and the receiving element, so that reliable reading is advantageously promoted. Alternatively, it is conceivable that the QR code or the plurality of QR codes is/are arranged on the outer side of the capsule bottom or on the outer side of the wall of the base element.

A further subject matter of the present invention is a brewing device for the system according to the invention or for use with the portion capsule according to the invention, the brewing device having a receiving element with a receptacle for the portion capsule and a closure element, the closure element being movable between a loading position, in which the receiving element and the closure element are spaced apart from one another, and an extraction position, in which the receiving element and the closure element are brought closer together to form an essentially closed brewing chamber, the receiving element, a housing of the brewing device or the closure element preferably having the identifier detector. In the extraction position, the closure element is in particular pressed against the capsule cover, so that a product identifier arranged on the capsule cover, and in particular the QR code that represents the product identifier, can be read particularly easily and reliably by the identifier detector.

According to a preferred embodiment of the present invention, it is provided that the closure element has an opening on a side facing the receiving element, the identifier detector being arranged in the region of the opening within the closure element, the opening preferably being closed by a transparent window. In an advantageous way, the identifier detector can detect a product identifier arranged on the portion capsule through the opening. Preferably, the opening is closed by a transparent window, for example in the form of a transparent foil or a transparent glass, so that the identifier detector itself advantageously does not come into contact with pressurized, hot brewing liquid. Alternatively, it would also be conceivable that the receiving element has the opening and the transparent window. Optionally, the identifier detector is arranged in the insertion shaft, the bell or an immovable element of the brewing chamber. According to a preferred embodiment of the present invention, it is provided that the closure element has an essentially round contact area, facing the receiving element, for contact with the capsule cover in the extraction position, a detection area of the identifier detector and/or the opening being formed in the contact area. Preferably, the detection area and/or the opening is arranged in a region between 50 and 100 percent, preferably between 55 and 80 percent, particularly preferably between 60 and 70 percent, of the total radius of the contact area. Preferably, the detection area or the opening consequently lies in the region of the product identifier arranged on the capsule cover. In particular, the opening is arranged in a region between 20 and 100 percent, preferably between 30 and 70 percent, particularly preferably between 40 and 60 percent and most particularly preferably between 45 and 55 percent of the total radius of the contact area.

According to a preferred embodiment of the present invention, it is provided that the detection area and/or the opening has a second extent in the circumferential direction of the contact area, which is greater in the circumferential direction than the first extent. In an advantageous way, a complete product identifier, and in particular a complete QR code, can consequently be detected by the identifier detector. Preferably, the second extent in the circumferential direction is equal to or greater than the sum of the first extent and the spacing. In an advantageous way, each region of the QR code is consequently inevitably detectable by the identifier detector, irrespective of how the portion capsule happens to be oriented. In the case of this configuration, the product identifier must however possibly be made up of two different QR codes, if for example the spacing between the QR codes is arranged centrally in front of the detection area and/or the opening and on both sides of the spacing only a part of a neighboring QR code is in each case detectable for the identifier detector. Alternatively, it is conceivable that the second extent in the circumferential direction is equal to or greater than the sum of twice the first extent and the spacing or the sum of the first extent and twice the spacing. In the case of this configuration, it is ensured that there is always a QR code arranged completely in front of the detection area or the opening, irrespective of how the portion capsule happens to be oriented. Advantageously, the QR code does not have to be made up here in a fragmented manner of two QR code parts to be detected.

According to a preferred embodiment, the opening or the detection area is formed annularly on the contact area. It is conceivable that the detector is formed in the manner of an annular camera or rotates around the longitudinal axis of the brewing chamber along the annularly formed opening or detection area. In the case of this embodiment, the portion capsule optionally has only a single QR code on the circular ring.

According to a preferred embodiment of the present invention, it is provided that the closure element has a radiation source, and in particular a light source, for emitting visual and/or ultraviolet light in the direction of the portion capsule. In an advantageous way, the product identifier, and in particular the QR code, are illuminated by the light source, so that reading of the identifier by means of the identifier detector with the brewing chamber closed is made possible. The identifier detector is preferably designed for reading signals reflected by the portion capsule in the visual and/or ultraviolet wavelength range. It is conceivable that the identifier detector comprises for example a CCD camera, which is sensitive in the wavelength range of visual and/or ultraviolet light.

According to a preferred embodiment of the present invention, it is provided that the brewing device has evaluation electronics, which are coupled with the identifier detector and are intended for determining the product identifier by analysis of the detected QR code. Preferably, the evaluation electronics determine from the QR code the GS1 code, which allows a unique identification of the product or portion capsule arranged in the brewing chamber. The brewing device preferably also has a comparison unit, which is intended for comparing the specific product identifier with a list of prestored product identifiers. Alternatively, it is conceivable that the brewing device has an algorithm detection, which detects on the basis of an algorithm whether the detected QR code belongs to the system (that is to say is known) or is of a different system. The algorithm in this case functions on the basis of the known cryptographic methods of encryption/decryption.

According to a further preferred embodiment of the present invention, it is provided that product-relevant items of information, such as for example the use-by date of the beverage substance, are embedded in the product identifier and in particular in the QR code. In the detection of the product identifier, the identifier detector reads the product-relevant information and, in dependence on the product-relevant information, continues the brewing process, possibly with changed brewing parameters, or breaks it off. In this way it can be prevented for example that a beverage is brewed with a portion capsule that has already gone beyond the minimum use-by date, so that health risks when consuming the product are avoided. This is important in particular in the case of milk-based products.

It is conceivable that the identified GS1 code is compared with a list of prestored GS1 codes that are stored on a memory chip of the comparison unit and a brewing operation is started when there is a match with a prestored GS1 code. Preferably, each GS1 code prestored on the memory chip is linked with at least one specific brewing parameter that is used in the started brewing operation. For example, the amount of water, the water temperature, the brewing pressure and/or an interim action time are taken from the list as brewing parameters and are used appropriately when brewing with the associated portion capsule.

A further subject matter of the present invention is a method for handling a portion capsule, in a first method step at least one portion capsule and a sales packaging being provided with the same product identifier, in a second method step the sales packaging being filled with the at least one portion capsule, in a third method step the filled sales packaging being stored, transported and/or sold and in a fourth method step the portion capsule being removed from the sales packaging by a consumer, placed into a brewing device and the brewing device being started to extract a beverage from the portion capsule, characterized in that in the third method step the product identifier located on the sales packaging is read and evaluated in order to identify the portion capsule and/or the manufacturer of the portion capsule for logistical purposes, and in that in the fifth method step the product identifier located on the portion capsule is read and evaluated by an identifier detector of the brewing device in order to check the compatibility of the portion capsule with the brewing device.

According to a preferred embodiment of the present invention, it is provided that in the first method step the at least one portion capsule and the sales packaging are provided with a product identifier in the form of a GS1 code.

According to a preferred embodiment of the present invention, it is provided that in the first method step a bar code, an RFID card, a QR code, a line code, a dot code, a binary code, a Morse code, a Braille code or a data-matrix code, in which the product identifier is embedded, are printed onto the portion capsule and the sales packaging.

A further subject matter of the present invention is a method for operating a system according to the invention, in a first operating step the portion capsule according to the invention being inserted into the brewing device according to the invention, in a second operating step the brewing device being changed over from the loading position into the extraction position, in a third operating step the QR code arranged on the portion capsule being read by the identifier detector, in a fourth operating step the product identifier first being determined from the QR code and in a fifth operating step the extraction operation subsequently being initiated if the product identifier is identifiable, or in a fifth operating step the extraction operation first being initiated and in a subsequent fourth method step the product identifier being determined from the QR code and the extraction operation maintained or carried out according to a specific brewing program if the product identifier is identifiable.

In an advantageous way, the product identifier, i.e. the QR code, is only read by means of the identifier detector once the brewing chamber has been changed over to the extraction position, that is to say has been closed. This has the advantage that the position of the portion capsule is fixed and well defined in relation to the identifier detector, as a result of which a reliable and error-free detection operation can be achieved. Furthermore, impairment of the code identification is avoided by preventing stray light from being able to get into the closed brewing chamber from the outside. In the second alternative, the brewing operation is initiated before the QR code has been read and determined. This has the advantage that extraction liquid flowing in already causes a positive pressure to build up in the interior of the portion capsule, as a result of which the closure element lies flat against the identifier detector. It is conceivable that, before the QR code is read, the brewing operation is only carried out in the protected mode, i.e. with a lower temperature and/or lower brewing pressure, in order to reduce danger to the user and the machine. Nevertheless, error-free reading is thereby promoted. If the QR code is detected, the extraction operation is maintained or continued, in particular then with the required brewing parameters that are correct and/or match the capsule. It is also conceivable that, in the fifth method step, the brewing operation is changed in accordance with the detected product into a brewing program matching the detected portion capsule. If the QR code is not recognized, the brewing operation is broken off or the alternative process (also referred to as the protected mode), which comprises a cleaning operation, a brewing program with a reduced amount of brewing water, reduced brewing pressure and/or reduced brewing water temperature, is started or continued. The portion capsule is handled for example like a cleaning capsule, i.e. the brewing parameters of the extraction operation are set to a cleaning capsule. For example, cold or colder water than in a beverage brewing process is used. It is also conceivable that the brewing device in the protected mode operates for example with a lower brewing pressure, in order that bursting of a capsule of a different system is prevented when using pumping pressures of 19 bar, which the machine can deliver, and there is no danger to the user.

According to a preferred embodiment of the present invention, it is provided that in the fifth operating step an extraction operation with brewing parameters is initiated or continued, preferably at least one brewing parameter being selected in dependence on the identified product identifier. In an advantageous way, a brewing operation that is specifically made to match the brewing of the raw beverage material arranged in the portion capsule can be automatically initiated on the basis of the identification of the portion capsule.

For example, the amount of water, the water temperature, the brewing pressure and/or an interim action time are identified as brewing parameters on the basis of the product identifier and used in the associated extraction operation.

According to a preferred embodiment of the present invention, it is provided that in the third operating step the QR code is illuminated by a light source arranged on the closure element, in particular with visual and/or ultraviolet light, and light rays reflected by the QR code are detected by the identifier detector.

According to a preferred embodiment of the present invention, it is provided that in the fifth operating step the product identifier is compared with a list of prestored product identifiers.

According to a preferred embodiment of the present invention, it is provided that in the fifth operating step the brewing device is automatically moved back into the loading position, without an extraction operation or after breaking off the extraction operation, if the product identifier is not identified and in particular cannot be found on the list of prestored product identifiers.

A further subject matter of the present invention is a method for producing the portion capsule according to the invention, in a first production step a transparent cover foil being provided, in a second production step the QR code being printed onto a rear side of the cover foil, in a third production step the rear side of the cover foil being connected to a barrier foil and in a fourth production step the composite comprising the cover foil and the barrier foil being fastened on the base element. Preferably, the composite is adhesively attached and/or sealed on a peripheral flange of the base element. The QR code is on the one hand detectable by the identifier detector through the transparent cover foil and on the other hand protected by the transparent cover foil. The barrier foil advantageously ensures that the QR code and the cover foil do not come into contact with the raw beverage material, and consequently preferably do not have to be of a food-safe form. The production method makes high-speed, simple low-cost production of the portion capsule according to the invention possible.

According to a preferred embodiment of the present invention, it is provided that in the second production step an inscription and/or graphic is printed onto the rear side of the cover foil at a time after the printing on of the QR code. In an advantageous way, a visually appealing brand or decoration or the respective type of beverage may be printed on in the same production step for creating the QR code. The QR code is preferably printed on with an ink that is not visually perceptible and only becomes visible by illumination with ultraviolet light. The outer design of the capsule cover is consequently not impaired by the plurality of QR codes.

According to a preferred embodiment of the present invention, it is provided that in a fifth production step, carried out before after or during the third production step, the barrier foil is connected on a side facing away from the cover foil to a carrier foil. In the fourth production step, the capsule cover is connected to the base element in that the rear side of the barrier foil is adhesively attached or sealed onto the flange.

Further details, features and advantages of the invention emerge from the drawings and from the subsequent description of preferred embodiments on the basis of the drawings. The drawings thereby merely illustrate embodiments of the invention that are given by way of example and do not restrict the essential concept of the invention.

### BRIEF DESCRIPTION OF THE FIGURES

FIGS. 1a to 1e show schematic sectional views of a system and a method for producing a beverage according to an embodiment of the present invention that is given by way of example.

FIGS. 2a and 2b show schematic perspective views of the portion capsule of the system according to the embodiment of the present invention that is given by way of example.

FIG. 3 shows a sales packaging for the portion capsule of the system according to the embodiment of the present invention that is given by way of example.

FIGS. 4a and 4b show schematic views of a portion capsule according to an embodiment of the invention that is given by way of example.

FIGS. 5a and 5b show views of a detail of a brewing device of a system according to an embodiment of the present invention that is given by way of example.

FIG. 6 shows a schematic partial view of a portion capsule according to an embodiment of the invention that is given by way of example.

### EMBODIMENTS OF THE INVENTION

In the various figures, the same parts are always provided with the same designations, and are therefore generally also only referred to or mentioned once in each case.

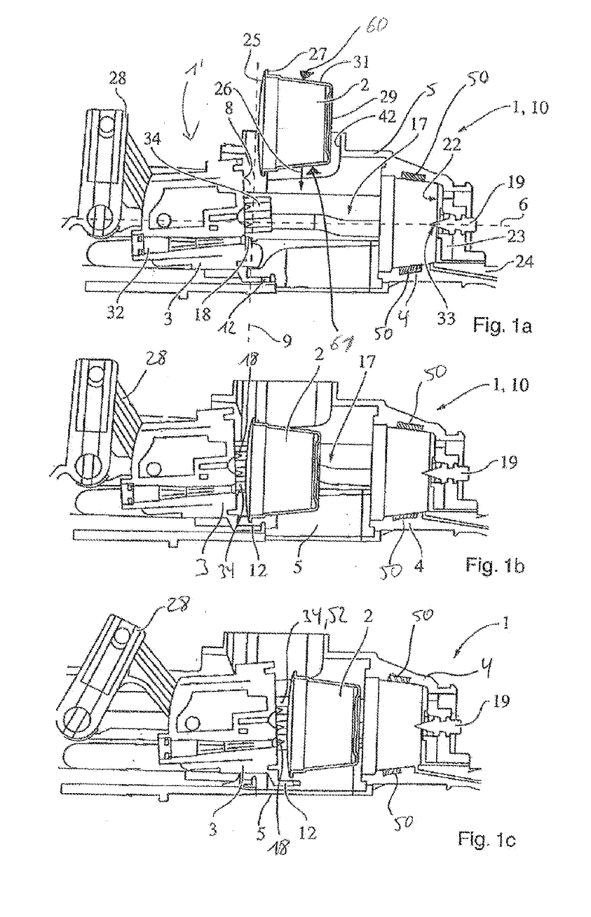

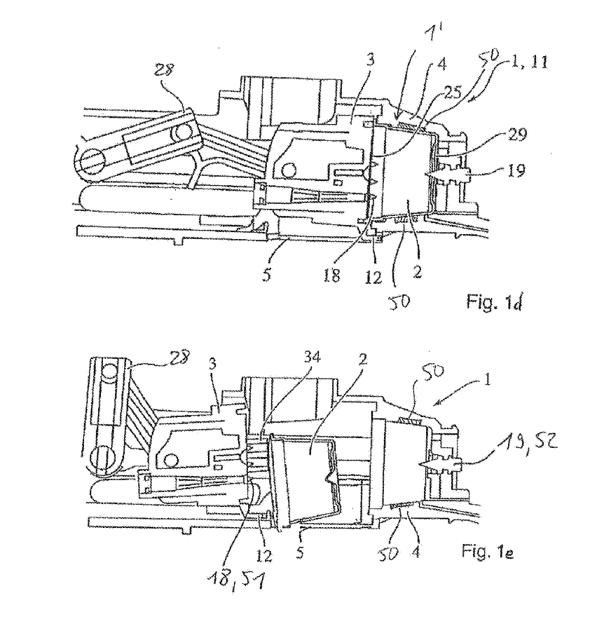

In FIGS. 1a to 1e, schematic sectional views are represented of a system 1 and a method for producing a beverage according to an embodiment of the present invention that is given by way of example. The system 1 comprises a brewing device 5 and a portion capsule 2. The brewing device 5 in this case comprises a receiving element 4, formed as a bell element, and a closure element 3. The closure element 3 is movable in relation to the receiving element 4 along an axial direction 6 between a loading position 10, illustrated in FIGS. 1a and 1b, and an extraction position 11, illustrated in FIG. 1d.

The portion capsule 2 comprises a truncated cone 31, produced from plastic and formed in a cup-like manner. The truncated cone 31 is closed in an airtight manner by means of a capsule cover 25 produced from plastic or aluminum foil. Within the portion capsule 2 there is a beverage substance, in particular a roasted coffee powder, that can be extracted by means of an extraction liquid. Optionally, the portion capsule 2 has a filtering element (not depicted), which is arranged between the capsule bottom 29 and the beverage substance. The capsule cover 25 is adhesively bonded or welded to the truncated cone 31 in the region of a capsule flange 27.

The closure element 3 has on an end face 8 facing the receiving element 4 a plurality of first perforation means 18. The first perforation means 18 respectively comprise a perforation point, which protrude from the end face 8 in the direction of the receiving element 4. Also formed in the end face 8 are water outlet openings (cannot be seen in FIGS. 1a to 1e for reasons of perspective). The closure element 3 also has a water supply channel 32, which is intended for supplying extraction liquid to the water outlet openings. The closure element 3 has two lateral retaining arms 34, the free ends of which are facing one another and laterally enclose the capsule flange 27. The receiving element 4 has a second perforation means 19, which comprises a piercing point, which points in the direction of the closure element 3 and is arranged within the cavity. The piercing point is provided with lateral grooves 33, which extend parallel to the axial direction 6. In the region of the piercing point, the receiving element 4 has a depression 23 in the bottom region 22 of the cavity, into which an outlet channel 24 opens out.

In FIG. 1a, the closure element 3 is illustrated in the loading position 10, i.e. the closure element 3 is spaced apart from the receiving element 4 along the axial direction 6. In this starting position, the portion capsule 2 is then inserted by a user (not depicted) along a loading direction 26 into an insertion shaft 42, so that the portion capsule 2 falls under the effect of gravitational force into an intermediate region between the closure element 3 and the receiving element 4.

In FIG. 1b it is illustrated that in the intermediate region the portion capsule 2 comes up against a capsule stop 12 and rests there. At the same time, tilting of the portion capsule 2 in the direction of the receiving element 4 is prevented by the lateral retaining arms 34, in that the capsule flange 27 is supported in the direction of the receiving element 4 on the retaining arms 34, so that the portion capsule 2 is aligned essentially axially along the axial direction 6.

In the next step, illustrated on the basis of FIG. 1c, the closure element 3 is driven by way of a toggle joint 28 to perform a linear displacement along the axial direction 6 in the direction of the receiving element 4. The movement of the closure element 3 in the direction of the receiving element 4 has the effect that the portion capsule 2 is inserted into the cavity of the receiving element 4.

In FIG. 1d, the closure element 3 has been displaced up to the receiving element 4 along the axial direction 6 into the extraction position 11, so that the portion capsule 2 is inserted virtually completely in the cavity of the hollow bell element. The capsule cover 25 has in this case been perforated by the first perforation means 18, formed as perforation points, while the capsule bottom 29 has been perforated by the second perforation means 19, formed as a piercing spike. The closure element 3 and the receiving element 4 thus form a hermetically closed brewing chamber 1′, in which the portion capsule 2 is arranged. The capsule flange 27 is in this case firmly clamped between the closure element 3 and the receiving element 4, in particular by means of an elastic sealing ring 36. The capsule stop 12 is in this case arranged underneath the receiving element 4.

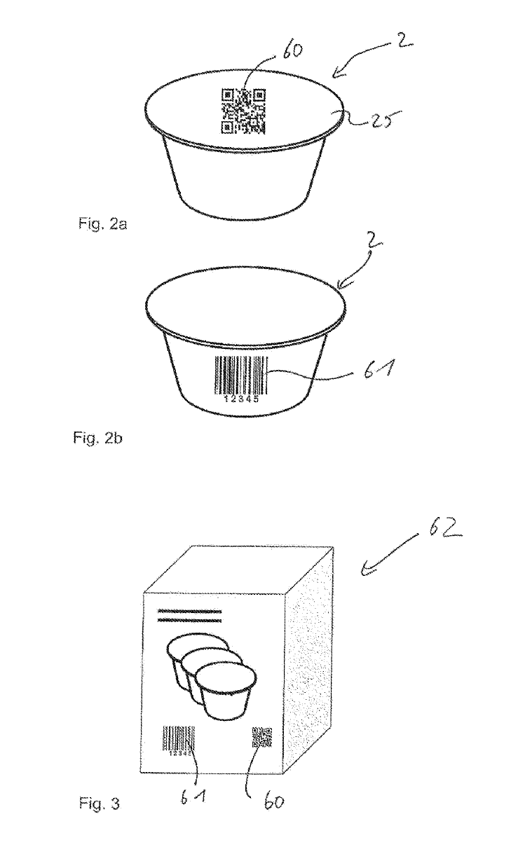

The brewing device 5 has an identifier detector 50 in the form of a peripheral optical camera. The camera is designed to read a data-matrix code or QR code 60 or bar code 61 arranged on the wall of the portion capsule 2. Such a portion capsule 2 is shown for example in FIGS. 2a and 2c. Embedded in the data-matrix code or QR code 60 or bar code 61 is a product identifier, in particular a product identification number in the form of a GS1 code. With the identifier detector 50, the product identifier is read and compared with a list of product identifiers prestored in the brewing device 5. If the detected product identifier coincides with a prestored product identifier, it is assumed that it is a system-own portion capsule 2, which can without any hesitation be used for extraction by means of the brewing device 5. A control circuit is then closed, allowing a pump (not depicted) for feeding extraction liquid to be switched on, as a result of which the extraction liquid in the form of pressurized, heated water is supplied to the brewing chamber 1′.

The extraction liquid is in this case fed by means of the pump through the water supply channel 32 to the water outlet openings and passes from there through the perforation openings produced by means of the first perforation means 18 in the capsule cover 25 into the portion capsule 2. The beverage substance is flowed through by the extraction liquid, so as to form a beverage extract, which leaves the portion capsule 2 again through the perforation hole produced in the capsule bottom 29 by means of the piercing spike and subsequently passes into the outlet channel 24. By means of the outlet channel 24, the beverage extract is preferably supplied directly to a drinking vessel (not depicted), such as for example a coffee cup.

After the extraction operation, the closure element 3 is moved from the extraction position 11 back again in the direction of the loading position 10, as illustrated in FIG. 1e. The extracted portion capsule 2 is thereby pulled out again from the cavity of the receiving element 4 by means of the retaining arms 34 and transported in the direction of the loading position 10. The return of the closure element 3 has the effect that the capsule flange 27 comes up against a stop face of a capsule ejector that is facing the receiving element 4. As a result, the used portion capsule 2 falls under the effect of gravitational force into a collecting container (not shown) arranged underneath the intermediate region. Subsequently, the closure element 3 is in the loading position 10 again, so that renewed filling of the brewing device 5 with an unused portion capsule 2 according to FIG. 1a is possible.

If the product identification number does not coincide with a prestored product identification number, the control circuit remains interrupted, so that the pump cannot be switched on and extraction of the portion capsule of a different system is prevented. It is conceivable that a corresponding visual or acoustic error signal is generated, signaling to the user of the system the incompatibility of the portion capsule 2 that is being used. Alternatively, it would also be conceivable that the brewing chamber 1′ is opened by an automatic return of the closure element 3 and the portion capsule 2 of the different system is thereby automatically ejected into the collecting container.

It would also be conceivable that, after insertion, the extraction operation is initially started in a protected mode, for example with lower pressure or temperature, in which there is no damage to the machine or danger to the user even in the case of a capsule of a different system, and, when the portion capsule is detected, the “matching extraction operation”, i.e. with the required pressure or the required temperature, is initiated. If the product identifier is not recognized, the protected mode is maintained, i.e. a brewing program with a reduced amount of brewing water, reduced brewing pressure and/or reduced brewing water temperature, is carried out, or an alternative process is initiated. The alternative process preferably comprises a cleaning operation or the ejection of the capsule. In the protected mode, preferably the brewing pressure is reduced, so that the pump output of the device of up to 19 bar, which in the case of a portion capsule of a different system may lead to bursting, does not present any danger to the user.

Preferably, after the insertion and closing of the brewing chamber, the extraction operation is initially started in the protected mode, the product identifier is subsequently detected and after that the protected mode is maintained if the product identifier is not recognized, or a change is made to the actual brewing mode that matches the portion capsule if the product identifier is recognized and/or can be assigned to a specific type of portion capsule.

Optionally, items of product-relevant information, such as for example the use-by date of the beverage substance, are embedded in the product identifier, and in particular in the QR code. In the detection of the product identifier, the identifier detector reads the product-relevant information and, in dependence on the product-relevant information, continues the brewing process, possibly with changed brewing parameters, or breaks it off. In this way, it can for example be prevented that a beverage is brewed with a portion capsule that has already gone past the minimum use-by date, so that health risks when consuming the product are avoided. This is important in particular in the case of milk-based products.

In an alternative embodiment, it is also conceivable that the portion capsule 2 comprises an RFID chip, in which the product identification number is embedded. In this case, the identifier detector 50 comprises a transmitting and receiving antenna in order to read the RFID chip.

In FIGS. 2a and 2b, schematic perspective views are shown of the portion capsule 2 according to two different embodiments of the present invention. In FIG. 2a, the cover 25 of the portion capsule 2 is provided with a QR code 60, while in FIG. 2b the wall of the portion capsule 2 is printed with a bar code 61. In both cases, the QR code 60 or the bar code 61 serves for providing the product identifier which is read by the identifier detector 50.

In FIG. 3, a schematic view is shown of a sales packaging 62, in which the portion capsule 2 is arranged while it is on sale or before being loaded into the brewing device 5. The sales packaging 62 is provided with the same product identifier as the portion capsule 2 located in the sales packaging 62. For this, the sales packaging is for example likewise provided with a QR code 60 or a bar code 61.

FIGS. 4a and 4b show schematic views of a portion capsule 2 of a system 1 according to an embodiment of the invention that is given by way of example. The portion capsule 2 comprises a base element 31 and a capsule cover 25. On the capsule cover 25, a multiplicity of QR codes 60 are arranged in a rotationally symmetrical manner. The QR codes 60 are in this case arranged on a circular path one behind the other along the circumference of the capsule cover 25. The QR codes 60 are in this case arranged in the peripheral region of the capsule cover 25. In the present example, the QR codes 60 are in this case arranged around the center point of the capsule cover 25 in the region with a radius 70 of between 55 percent and 65 percent of the total radius of the capsule cover (i.e. the distance between the center point of the capsule cover and the outer periphery of the capsule cover). The mean diameter of the circular path of QR codes 60 preferably lies at essentially 26 millimeters. Each QR code 60 is preferably of a square form, the edge length lying at essentially 1.8 millimeters. All of the QR codes 60 are in this case identical and respectively represent the product identifier taking the form of the GS1 code. The QR codes 60 are in particular printed on the capsule cover 25 with an ink that is not visually perceptible for the human eye in daylight and is only visually perceptible when specifically illuminated with ultraviolet light of an artificial light source. The design of the capsule cover 25 is consequently not impaired by the QR codes 60, which in FIGS. 4a and 4b are merely shown for purposes of illustration.

In an alternative embodiment, it is provided that the QR codes are arranged in the region of a circular path with a radius of between 20 and 100 percent, preferably between 30 and 60 percent, particularly preferably between 40 and 60 percent and most particularly preferably between 45 and 55 percent of the total radius of the capsule cover. The mean diameter of the circular ring of QR codes preferably lies between 10 and 20 millimeters, particularly preferably between 12 and 15 millimeters and particularly preferably at essentially 13.5 millimeters. Each QR code is preferably of a square form, the edge length preferably lying between 1 and 20 millimeters, preferably between 1 and 5 millimeters, particularly preferably between 1.5 and 2.1 millimeters and particularly preferably at essentially 1.8 millimeters. The spacing between two neighboring QR codes along the circular ring preferably lies between 1 and 2 millimeters, particularly preferably between 1.2 and 1.8 millimeters and particularly preferably at essentially 1.5 millimeters.

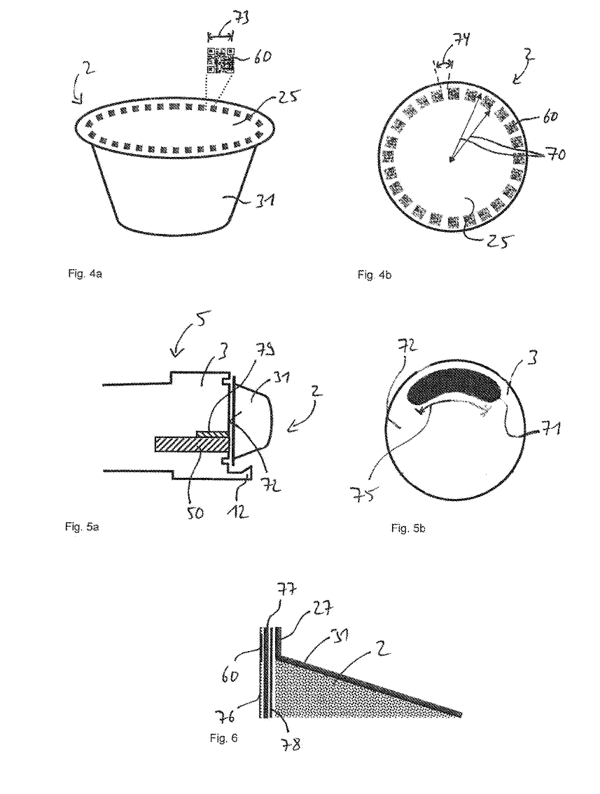

In FIGS. 5a and 5b, views are represented of a detail of a brewing device 5 of a system 1 according to an embodiment of the present invention that is given by way of example, only the closure element 3 being shown for reasons of overall clarity. The brewing device 5 is based on the brewing device 5 and the functioning illustrated in FIGS. 1a to 1e. As a difference, the brewing device 1 according to FIGS. 5a and 5b has in the closure element 3 an identifier detector 50, which takes the form of an optical camera, in particular a CCD chip, in the upper region of the closure element 3. For this, the closure element 3 has an opening 71, which is closed by a transparent panel and is formed in a contact area 72 that is facing the receiving element 4 (not represented in FIGS. 5a and 5b). Once the brewing chamber 1′ has been closed and changed over into the extraction position (cf. FIG. 1d), and optionally the extraction operation has already been started, the contact area 72 is pressed against the capsule cover 25, so that at least one data-matrix code or QR code 60 is pressed flat against the panel of the opening 71. The closure element 3 has a light source 79, which illuminates the region of the capsule cover 25 that is arranged in front of the opening 71 with ultraviolet light. Subsequently, the light rays reflected by the data-matrix code or QR code 60 are recorded by the identifier detector 50 and the recorded data-matrix code or QR code 60 is analyzed by means of evaluation electronics and the associated GS1 code is determined from the data-matrix code or QR code 60. The brewing device 5 also has a comparison unit, which then compares the GS1 code with a list of prestored GS1 codes in order to determine the type of the portion capsule 2. If the GS1 code is identical to a GS1 code in the list, the extraction operation is started or maintained and, by supplying brewing liquid, a beverage is brewed with prescribed brewing parameters from the raw beverage material located in the portion capsule 2.

The data-matrix codes or QR codes respectively have in the circumferential direction a maximum first extent 73 that is typically can be pronounced surprisingly preferably equal to 1.9 millimeters. A spacing 74 is respectively provided between two neighboring data-matrix codes or QR codes 60. A maximum second extent 75 of the opening 71 in the circumferential direction is at least equal to or greater than the sum of the first extent 73 and the spacing 74. In this way it is ensured that, irrespective of how the portion capsule 2 happens to be oriented with respect to its longitudinal axis in the brewing chamber 1′, always at least all of the parts of a data-matrix code or QR code 60, if also possibly in two parts that are separate from one another, are detectable by the identifier detector 50. The separate parts of the data-matrix code or QR code 60 must possibly then be put together again for the evaluation by the evaluation electronics.

Alternatively, it is conceivable that the maximum second extent 75 is equal to or greater than the sum of twice the first extent 73 and the spacing 74 or equal to or greater than the sum of the first extent 73 and twice the spacing 74 (depending on which value is smaller). In the case of this configuration, it is ensured that there is always a contiguous data-matrix code or QR code 60 arranged completely in front of the opening 71, irrespective of how the portion capsule 2 happens to be oriented in the brewing chamber 1′.

In FIG. 6, a schematic partial view is represented of a portion capsule 2 according to an embodiment of the invention that is given by way of example. The partial view shows here in particular the construction of the capsule cover 25. The capsule cover 25 comprises a transparent cover foil 76, on the rear side of which the data-matrix code or QR code 60 is printed in the peripheral region and on the rear side of which, according to requirements, graphic elements, such as logos or graphics, are additionally printed. The transparent cover foil 76 has subsequently been adhesively attached onto a transparent foil, which acts as a background for the cover foil 76. The transparent foil acts at the same time as a largely air-impermeable barrier foil 77, which serves for the hermetic closing of the portion capsule 2. The barrier foil 77 is additionally connected to a white carrier foil 78, which is adhesively attached or sealed on the peripheral flange 27 of the frustoconical base element 31.

### LIST OF DESIGNATIONS

1 System

1′ Brewing chamber

2 Portion capsule

3 Closure element

4 Receiving element

5 Brewing device

6 Axial direction

8 End face

10 Loading position

11 Extraction position

12 Capsule stop

18 First perforation means

19 Second perforation means

22 Bottom region

23 Depression

24 Outlet channel

25 Capsule cover

26 Loading direction

27 Capsule flange

28 Toggle joint

29 Capsule bottom

31 Truncated cone

32 Water supply channel

33 Groove

34 Retaining arm

42 Insertion shaft

50 Identifier detector

60 QR code

61 Bar code

62 Sales packaging

70 Radius

71 Opening

72 Contact area

73 First extent

74 Spacing

75 Second extent

76 Transparent cover foil

77 Barrier foil

78 Carrier foil

79 Light source/radiation source

1. A system for preparing a beverage having a portion capsule, which is filled with a raw beverage material, and a brewing device, which comprises a brewing chamber for receiving the portion capsule and for extracting the beverage from the portion capsule by means of extraction liquid, characterized in that the portion capsule has a product identifier and in that the brewing device has an identifier detector for identifying the identification of the portion capsule.

2. The system as claimed in claim 1, the product identifier being a GS1 code.

3. The system as claimed in claim 1, the product identifier being embedded in a bar code, an RFID code, a QR code, a data-matrix code, a line code, a dot code, a binary code, a Morse code, a Braille code or the like.

4. The system as claimed in claim 1, the brewing device comprising a control unit which only initiates an extraction if the identifier detector detects a known product identifier.

5. The system as claimed in claim 1, the brewing device comprising a control unit which starts a specific brewing program in dependence on the product identifier detected by the identifier detector.

6. The system as claimed in claim 1, the brewing device comprising a control unit which initiates an alternative process if the identifier detector detects an unknown product identifier.

7. The system as claimed in claim 6, the alternative process comprising a capsule ejecting operation, a cleaning operation or a brewing program with a reduced amount of brewing water, a reduced brewing rate, a reduced brewing pressure and/or a reduced brewing water temperature.

8. The system as claimed in claim 1, the system having a sales packaging in which the portion capsule is arranged before placement in the brewing device, the sales packaging being provided with the same product identifier.

9. The system as claimed in claim 8, the product identifier arranged on the sales packaging being intended for identifying and tracking the portion capsule arranged in the sales packaging during the transport, storage and/or sale of the portion capsule.

10. A portion capsule for a system as claimed in claim 1, the portion capsule having a frustoconical base element with a cavity for receiving the raw beverage material and a capsule cover closing the cavity, the product identifier being arranged in the region of the capsule cover and/or in the region of a capsule flange and/or on the base element.

11. The portion capsule as claimed in claim 10, the product identifier being embedded in a QR code and a plurality of the QR codes being arranged on a circular path one behind the other in the circumferential direction on the capsule cover.

12. The portion capsule as claimed in claim 11, the QR codes being arranged in the region of a circular path with a radius of between 40 and 100 percent, preferably between 50 and 80 percent and particularly preferably between 55 and 65 percent of the total radius of the capsule cover.

13. The portion capsule as claimed in claim 12, the QR codes being arranged in the region of a circular path with a radius of between 20 and 100 percent, preferably between 30 and 70 percent, particularly preferably between 40 and 60 percent and most particularly preferably between 45 and 55 percent of the total radius of the capsule cover.

14. The portion capsule as claimed in claim 12, each QR code having a maximum first extent in the circumferential direction and a spacing being respectively provided between two neighboring QR codes, the spacing being less than, equal to or greater than the first extent.

15. The portion capsule as claimed in claim 12, the portion capsule comprising at least one carrier foil and a transparent cover foil, the QR codes being arranged between the carrier foil and the cover foil and in particular being printed onto the rear side of the cover foil, preferably the carrier foil facing the base element and the cover foil facing away from the base element.

16. The portion capsule as claimed in claim 12, the QR code being printed with an ink that reflects ultraviolet light.

17. The portion capsule as claimed in claim 12, the base element having a peripheral flange, to which the capsule cover is fastened, the plurality of QR codes being arranged on a circular path one behind the other in the circumferential direction on an underside of the flange that is facing away from the capsule cover.

18. A brewing device for a system as claimed in claim 1, the brewing device having a receiving element with a receptacle for the portion capsule and a closure element, the closure element being movable between a loading position, in which the receiving element and the closure element are spaced apart from one another, and an extraction position, in which the receiving element and the closure element are brought closer together to form an essentially closed brewing chamber.

19. The brewing device as claimed in claim 18, the receiving element, a housing of the brewing device or the closure element having the identifier detector.

20. The brewing device as claimed in claim 18, the closure element having an opening on a side facing the receiving element, the identifier detector being arranged in the region of the opening within the closure element, the opening preferably being closed by a transparent window.

21. The brewing device as claimed in claim 18, the closure element having an essentially round contact area, facing the receiving element, for contact with the capsule cover in the extraction position, a detection area of the identifier detector and/or the opening being formed in the contact area.

22. The brewing device as claimed in claim 21, the detection area and/or the opening being arranged in a region between 50 and 100 percent, preferably between 60 and 90 percent and particularly preferably between 70 and 90 percent of the total radius of the contact area.

23. The brewing device as claimed in claim 21, the opening being arranged in a region between 20 and 100 percent, preferably between 30 and 70 percent, particularly preferably between 40 and 60 percent and most particularly preferably between 45 and 55 percent of the total radius of the contact area.

24. The brewing device as claimed in claim 18, the detection area and/or the opening having a second extent in the circumferential direction of the contact area, which is greater in the circumferential direction than the first extent.

25. The brewing device as claimed in claim 18, the second extent in the circumferential direction being equal to or greater than the sum of the first extent and the spacing.

26. The brewing device as claimed in claim 18, the second extent in the circumferential direction being equal to or greater than the sum of twice the first extent and the spacing or the sum of the first extent and twice the spacing.

27. The brewing device as claimed in claim 18, the closure element having a radiation source, and in particular a light source, for emitting visual and/or ultraviolet light in the direction of the portion capsule.

28. The brewing device as claimed in claim 18, the identifier detector being designed for reading signals reflected by the portion capsule in the visual and/or ultraviolet wavelength range.

29. The brewing device as claimed in claim 18, the brewing device having evaluation electronics, which are coupled with the identifier detector and are intended for determining the product identifier by analysis of the detected QR code.

30. The brewing device as claimed in claim 29, the brewing device having a comparison unit, which is intended for comparing the specific product identifier with a list of prestored product identifiers.

31. A method for handling a portion capsule, in a first method step at least one portion capsule and a sales packaging being provided with the same product identifier, in a second method step the sales packaging being filled with the at least one portion capsule, in a third method step the filled sales packaging being stored, transported and/or sold and in a fourth method step the portion capsule being removed from the sales packaging by a consumer, placed into a brewing device and the brewing device being started to extract a beverage from the portion capsule, characterized in that in the third method step the product identifier located on the sales packaging is read and evaluated in order to identify the portion capsule and/or the manufacturer of the portion capsule for logistical purposes, and in that in the fifth method step the product identifier located on the portion capsule is read and evaluated by an identifier detector of the brewing device in order to check the compatibility of the portion capsule with the brewing device.

32. The method as claimed in claim 31, in the first method step the at least one portion capsule and the sales packaging being provided with a product identifier in the form of a GS1 code.

33. The method as claimed in claim 31, in the first method step a bar code, an RFID code, a line code, a dot code, a binary code, a Morse code, a Braille code or a QR code, in which the product identifier is embedded, being printed onto the portion capsule and the sales packaging.

34. A method for operating a system as claimed in claim 1, in a first operating step a portion capsule being inserted into a brewing device, in a second operating step the brewing device being changed over from the loading position into the extraction position, in a third operating step the QR code arranged on the portion capsule being read by the identifier detector, in a fourth operating step the product identifier first being determined from the QR code and in a fifth operating step the extraction operation subsequently being initiated if the product identifier is identifiable, or in a fifth operating step the extraction operation first being initiated and in a subsequent fourth method step the product identifier being determined from the QR code and the extraction operation maintained or carried out according to a specific brewing program if the product identifier is identifiable.

35. The method as claimed in claim 34, in the fifth operating step an extraction operation with brewing parameters being initiated or continued, at least one brewing parameter being selected in dependence on the identified product identifier.

36. The method as claimed in claim 34, in the third operating step the QR code being illuminated by a light source arranged on the closure element, in particular with visual and/or ultraviolet light, and light rays reflected by the QR code being detected by the identifier detector.

37. The method as claimed in claim 34, in the fifth operating step the product identifier being compared with a list of prestored product identifiers.

38. The method as claimed in claim 34, in the fifth operating step the brewing device being moved back into the loading position, without an extraction operation or after breaking off the extraction operation, or an alternative process, such as in particular a capsule ejecting operation, a cleaning operation or a brewing program with a reduced amount of brewing water, a reduced brewing pressure and/or a reduced brewing water temperature, being started if the product identifier is not identified and in particular cannot be found on the list of prestored product identifiers.

39. A method for producing a portion capsule as claimed in claim 10, in a first production step a transparent cover foil being provided, in a second production step the QR code being printed onto a rear side of the cover foil, in a third production step the rear side of the cover foil being connected to a barrier foil and in a fourth production step the composite comprising the cover foil and the barrier foil being fastened on the base element.

40. The method as claimed in claim 39, in the second production step an inscription and/or graphic being printed onto the rear side of the cover foil at a time after the printing on of the QR code.

41. The method as claimed in claim 39, in a fifth production step, carried out before, after or during the third production step, the barrier foil being connected on a side facing away from the cover foil to a carrier foil.

42. The method as claimed in claim 39, in the second method step the QR code being printed on with an ink of which the visual perceptibility is increased by selective illumination with ultraviolet light.
